(19) United States
(12) Patent Application Publication
(10) Pub. No.: US 2016/0277476 A1
(43) Pub. Date: Sep. 22, 2016

(54) DISTRIBUTING CONTENT USING A SMARTPHONE

(71) Applicant: Eastman Kodak Company, Rochester, NY (US)

(72) Inventors: Thomas D. Pawlik, Rochester, NY (US); Richard A. Gammons, Webster, NY (US); Ronald S. Cok, Rochester, NY (US)

(21) Appl. No.: 14/662,277

(22) Filed: Mar. 19, 2015

(51) Int. Cl. H04L 29/08; H04L 12/24; H04L 12/58

(52) U.S. Cl. CPC H04L 67/02; H04L 51/10; H04L 41/22; H04L 67/10

(57) ABSTRACT

A method of distributing content using a smartphone (110) includes capturing an image of a machine-readable (102) code with the smartphone. The machine-readable code (102) is decoded to extract information which is transmitted from the smartphone (110) to a server computer (130). The information or content associated with the information from the server computer (130) is transmitted to a local computer (120) and the content associated with the information, or the information is displayed (150) on the local computer (120).

### FIELD OF THE INVENTION

The invention relates in general to distributing content using a smartphone and in particular to distributing content to a local computer.

### BACKGROUND OF THE INVENTION

Quick response (QR) codes are widely used in association with smartphones to access information from the internet. In such applications, a user captures an image of a printed QR code, the smartphone analyzes the QR code to extract a web address (URL), transmits the web address to an internet-based web server that retrieves content associated with the web address (typically in hypertext markup language or html) and transmits the retrieved content to the smartphone where it is displayed in a web browser. An example of content is a textbook or magazine wherein additional information pertaining to the printed subject matter is accessible via a URL encoded as a barcode or QR code.

Such a system, although useful, is limited in that the retrieved content is not readily or effectively displayed on a device separate from the smartphone or shared with a group. Moreover, a smartphone is limited in that much content must be displayed piecemeal on the small screen of the smartphone.

In prior art systems, the limitation of sharing with a group is often addressed by plugging a projector display into a local computer such as a PC. However, such personal computers do not have ready access to devices that can scan printed material. Tethered barcode readers are available. These would, however, add cost to the textbook. Marketing campaigns that distributed reader hardware along with printed content have not been very successful (e.g. the CueCat barcode reader distributed with a magazine). Alternatively, smartphones include digital cameras and code decryption capabilities to read barcodes and are readily portable, but are not equipped for display with separate devices or sharing with groups.

In another prior-art embodiment, a direct connection is established between the mobile device and the stationary device using the mobile device as a barcode scanner and the scan data is transferred, for example, via Bluetooth. This solution only works for 1:1 relationships and it requires the establishment of an additional data connection.

There is a need, therefore, for a cost-effective system that can scan printed codes, extract code information from the printed code, and effectively share retrieved content associated with the coded information with a group.

### SUMMARY OF THE INVENTION

Briefly, according to one embodiment of the present invention, a method of distributing content using a smartphone includes capturing an image of a machine-readable code with a smartphone. The machine-readable code is decoded to extract information from the machine-readable code (code information) that is transmitted from the smartphone to a server computer. The code information or content associated with the code information is then transmitted from the server computer to a local computer and the content associated with the code information, or the transmitted code information itself, is displayed on the local computer or a display device connected to the local computer.

The present invention leverages the well-established internet connectivity of a mobile communication device (smartphone) and a local computer. Both devices are identified to a network-connected server computer using login credentials. When a user scans a machine-readable code using the smartphone to extract code information, the code information is sent to the server. Subsequently the code information or content related to the code information is sent to the local computer and displayed there. The present invention is distinguished from conventional retrieval of HTTP content through a web browser in that the content is not displayed on the requesting client (i.e. on the smartphone) but rather on a second computer that is linked to the smartphone via a common user identification (user name and password).

The invention and its objects and advantages will become more apparent in the detailed description of the preferred embodiment presented below.

### BRIEF DESCRIPTION OF THE DRAWINGS

FIG. 1 is a schematic of one embodiment of the present invention showing display of additional content;

FIG. 2 is a schematic of another embodiment of the present invention showing simultaneously display of additional content;

FIG. 3 is a schematic of yet another embodiment of the present invention with multiple users;

FIG. 4 is a schematic of a smartphone and local computer as used in the present invention;

FIG. 5 is a flow chart of an embodiment of the present invention; and

FIG. 6 is another flow chart of an embodiment of the present invention.

### DETAILED DESCRIPTION OF THE INVENTION

The value of a printed textbook can be enhanced by providing added content that is available to the purchaser of the book. The added content could comprise sound files, music clips, videos, pictures, text with hyperlinks, web pages, and interactive software applications (such as java-based applets). At particular positions within the textbook, machine-readable codes (e.g. linear barcodes, QR codes or data-matrix codes) can encode information that provides links to this added content. Other media that can be used to display the machine-readable codes include books, newspapers, magazines, posters, billboards, television, soft-copy display screens (e.g. connected to a computing device), or direct mail. The information stored in the machine-readable code can include an alphanumeric string, a web address, a security code, a user identifier, an organization identifier, a smartphone identifier, a computer program identifier, a telephone number, geographic location coordinates, an image, or an access code that specifies referenced content or a class of content.

According to the prior art, a student uses a smartphone to scan the printed code and views retrieved content associated with information stored in the printed code. This renders the smartphone temporarily unavailable for social interactions and the size and quality of the screen may not be optimal to display a lot of information. Moreover, it is difficult to share the retrieved information with other viewers. According to embodiments of the present invention, the retrieved information is shared with other viewers with a network-connected laptop, desktop PC or tablet having a larger display screen or projector after scanning the barcode with the smartphone. The smartphone is then available for other tasks after the scanning step.

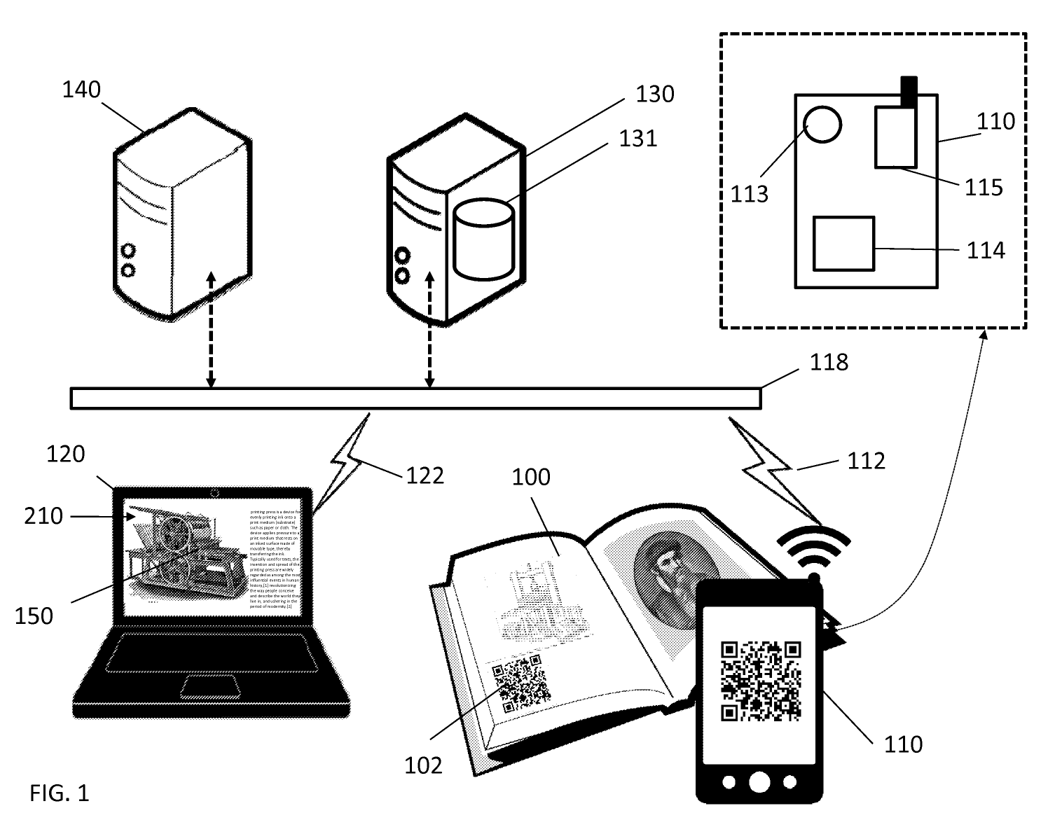

FIG. 1 is a schematic diagram of one embodiment of the present invention. A printed article 100, for example a textbook or magazine publication, contains a machine-readable code 102 next to printed information on a subject matter. The machine-readable code 102 can be a QR code, barcode, data matrix code, or image and provides a link to additional content pertaining to the subject matter. In an embodiment, both a smartphone 110 and a local computer 120 are in proximity to the printed article 100 and both are connected to a network 118. The smartphone 110 includes an image-capture device 113 for capturing an image of the machine-readable code 102, a processor 114 for decoding the machine-readable code 102 to extract code information, and a transmitter 115 for transmitting the code information over the network 118.

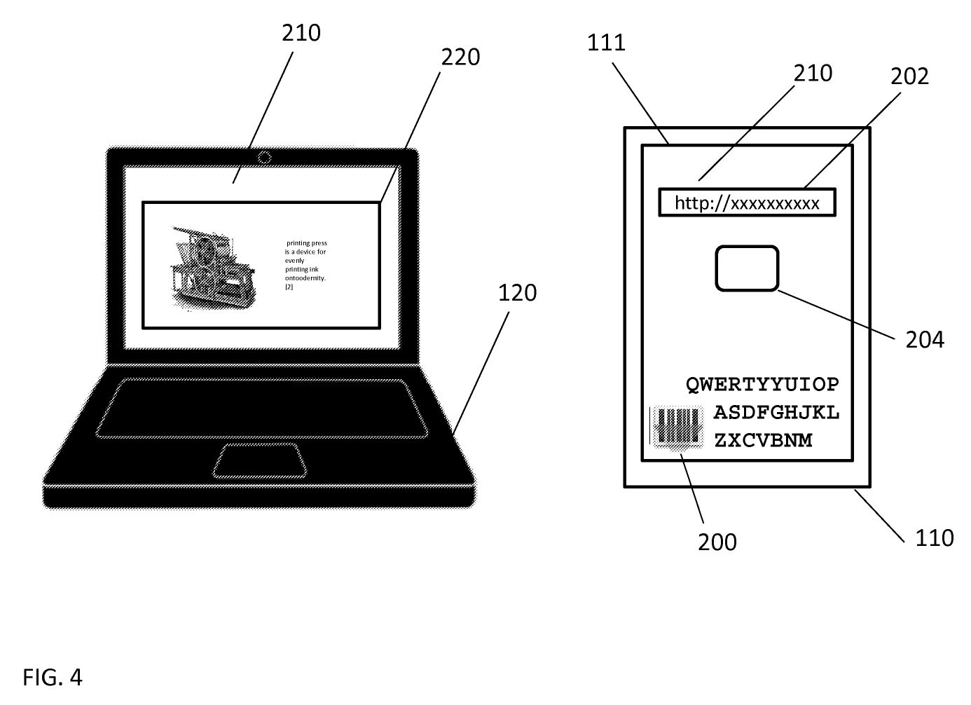

Both the smartphone 110 and the local computer 120 are able to access a server computer 130 over the network 118 via wireless or wired data transmission links 112 and 122, for example a local wired network, a wireless network such as WiFi, a wireless cellular network, or the internet. The server computer 130 contains directly connected memory 131 and a program that processes requests using the Hypertext Transfer Protocol (HTTP) and serves files that specify web pages to the smartphone 110 and the local computer 120, both of which contain HTTP clients that forward the requests and display web pages and other content, for example with a web browser 210 (FIG. 4).

At the beginning of the interaction, a user has identified himself or herself to the server computer 130 via a user account, for example, by providing a login name and password. The user account has been previously set up on the server computer 130. When an image of the machine-readable code 102 is captured by the smartphone 110 and decoded, the code information extracted from the decoded machine readable code 102 is transmitted to the server computer 130 via the network 118, for example a wireless data transmission link such as WiFi or a cellular data protocol. In one embodiment, the server computer 130 interprets the incoming data as a link to content that is stored in a memory in the server computer 130 or on other linked remote data sources 140. For example, the transmitted information can contain a Uniform Resource Locator (URL) such as, for example, “http://www.textbookpress.com/activecontent/Gutenberg_press.html”

The content distributed to the local computer 120 is, for example, the file Gutenberg_press.html which contains data in html format that can be displayed by an HTTP client. This data file is sent to the local computer 120 via the network 118, for example, wireless data transmission link 122 and is received, interpreted and displayed by the HTTP client 210 (web browser) on the local computer 120. Alternatively, the server computer 130 can transmit the URL itself to the local computer 120 and the local computer 120 uses the URL link to request and retrieve the associated content from a remote data source 140 and displays the associated content in the web browser 210.

The smartphone 110 can transmit additional information to the server computer 130 such as a security code, a user identifier, an organization identifier, a smartphone identifier, a computer program identifier, a telephone number, geographic location coordinates, or an image. This additional information can be used by the server computer 130 to adjust the content provided to the local computer 120 based on user permissions, purchase of access rights, membership status, user age, geographic location and other metadata.

The smartphone 110 can also transmit a token that provides access, e.g. a security code or it can transmit an identifier that references access rights and tokens stored on the server computer 130. This ensures that access rights to the content can be managed at the server site. Access rights could for example be based on an additional purchase transaction or age.

An important difference between the present invention and the conventional retrieval of HTTP content through a web browser is that the content is not displayed on the requesting client (i.e. on the smartphone), but rather on a second computer (e.g., local computer 120) that is linked to the smartphone 110 via a common user identification (user name and password).

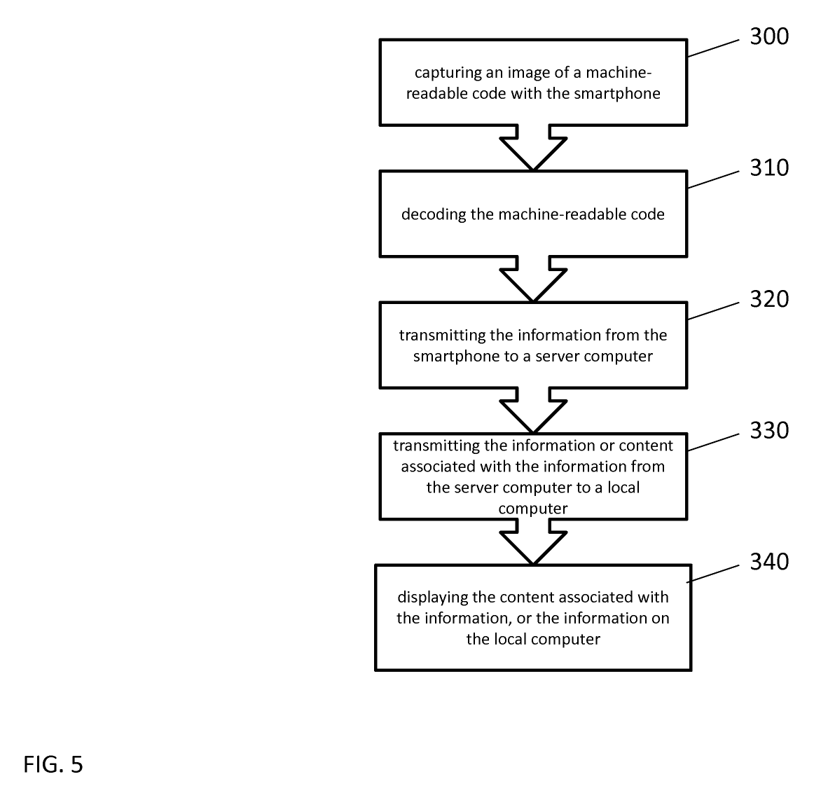

Thus, referring to the flow chart of FIG. 5, in a useful embodiment of the present invention, a method of distributing content using a smartphone comprises capturing an image of a machine-readable code 102 with the smartphone 110 in step 300, decoding the machine-readable code 102 to extract information from the machine-readable code 102 in step 310, transmitting the information from the smartphone 110 to a server computer 130 in step 320, transmitting the information or content associated with the information from the server computer 130 to a local computer 120 in step 330, and displaying the content associated with the information or the information on the local computer 120 in step 340. In an embodiment, the information is a reference to remotely stored content and the server computer 130 retrieves the content using the reference or the local computer 120 retrieves the content using the reference.

In another embodiment, a method of distributing content using a smartphone 110 includes capturing an image of a machine-readable code 102 with the smartphone 110 in step 300, decoding the machine-readable code 102 to extract information from the machine-readable code 102 in step 310, transmitting a user name and the information to a server computer 130 in step 320, retrieving content associated with the information at the server computer 130, transmitting the retrieved content to a local computer 120 in step 330, and displaying the retrieved content at the local computer 120 in step 340. In this embodiment, data is transmitted from the smartphone 110 to the server computer 130 in addition to the information extracted from the machine-readable code 102. The additional data can include identification information, such as a username or password, or both. This workflow provides increased security.

Alternatively, a method of distributing content using a smartphone 110 includes capturing an image of a machine-readable code 102 with the smartphone 110 in step 300, transmitting the image of the machine-readable code 102 from the smartphone 110 to a remote server computer 130 in step 320, decoding the machine-readable code 102 to extract information from the machine-readable code 102, for example with the remote server computer 130, retrieving content associated with the information, for example with the remote server computer 130, transmitting the information or retrieved content associated with the information from the server computer 130 to a local computer 120 in step 330, and displaying or playing the retrieved content associated with the information or the information on the local computer 120 in step 340. In this embodiment, an image of the machine-readable code 102 is transmitted from the smartphone 110 to the server computer 130 and the information is extracted from the machine-readable code 102 by the server computer 130 rather than the smartphone 110. This workflow provides increased computing capability for extracting the information from the machine-readable code 102 and is particularly useful in a thin client system (i.e. a smartphone with limited capability).

In yet another embodiment, a system for distributing content including a smartphone 110 includes a network 118 for transmitting information and content, a smartphone 110 connected to the network 118 wherein the smartphone 110 includes an image-capture device 113 for capturing an image of the machine-readable code 102, a processor 114 for decoding the machine-readable code 102 to extract information, and a transmitter 115 for transmitting the information over the network 118. A server computer 130 is connected to the smartphone 110 by the network 118. The server computer 130 includes a receiver for receiving information from the smartphone 110, a processor for retrieving content, and a transmitter for transmitting either the information or retrieved content associated with the information over the network (not shown in FIG. 1). A local computer 120 includes a receiver for receiving the retrieved content or information over the network 118 from the server computer 130 and a display for displaying the retrieved content, retrieved content associated with the information, or the information. The local computer 120 can include an output device for displaying the retrieved content, retrieved content associated with the information, or the information.

In a further embodiment of the present invention, the information extracted from the machine-readable code 102 (code information) is a reference to remotely stored content and the server computer 130 retrieves the content using the reference. In yet another embodiment, the local computer 120 retrieves the content using the reference. The information can be displayed on the local computer 120 or a device connected to the local computer 120 (e.g. a projector). The server computer 130 can retrieve content associated with the information from a remote source (e.g. through a network link) or from a memory directly connected to the server computer 130 (e.g. a local storage device or memory 131). In another embodiment, the information is a reference to content stored on the local computer 120.

In yet another embodiment, the information extracted from the machine-readable code 102 includes access permission to the referenced content. For example, content is copyrighted and a purchaser of the printed machine-readable code purchases the right to display, view, or copy, the referenced content. The referenced content can be a webpage, video clip, image, software program, text, or music clip. In a useful embodiment, the information is a content reference (for example a universal resource locator) and content is retrieved by the smartphone 110.

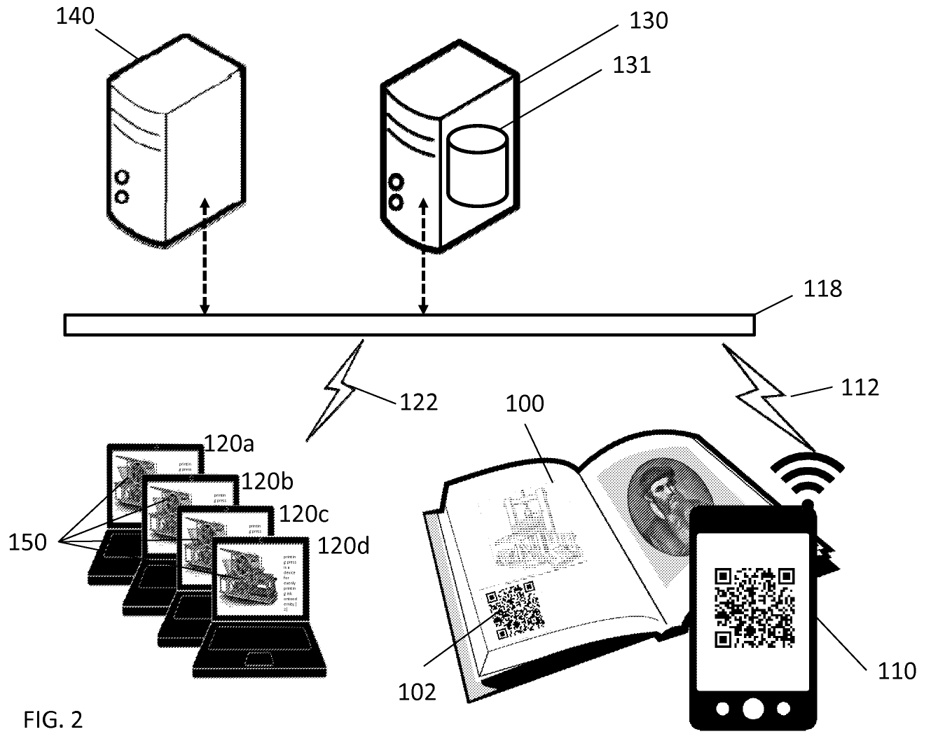

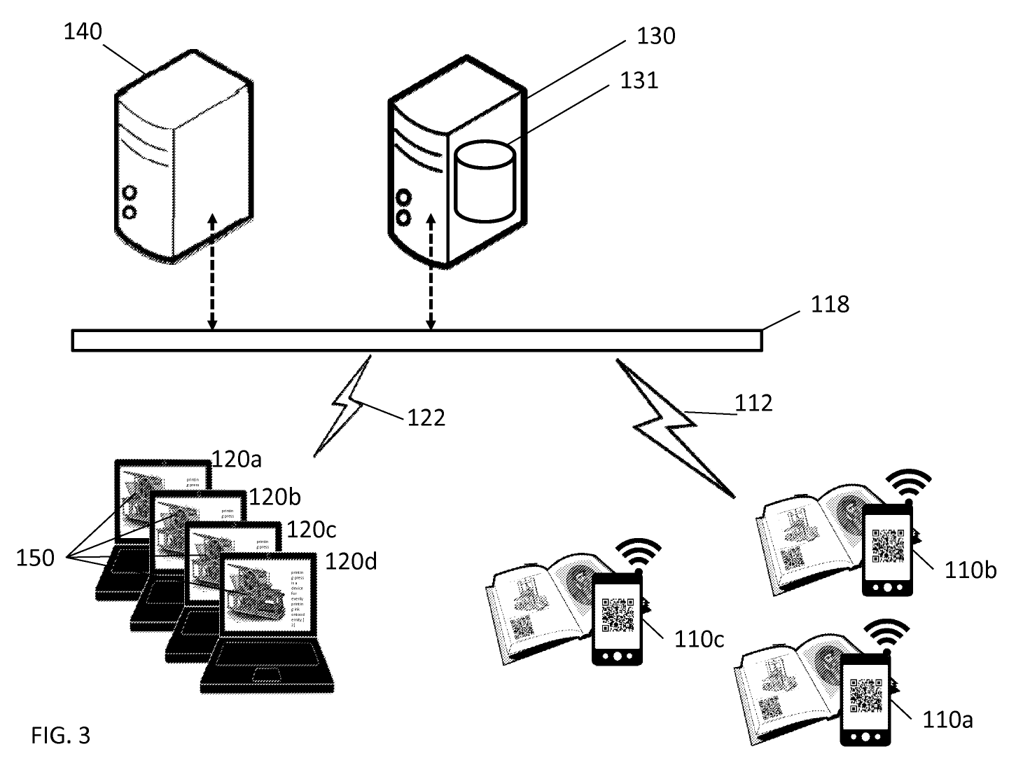

The system of the present invention is not confined to a 1:1 relationship between requesting smartphone 110 and local computer 120. Based on the usage of user credentials multiple N:N relationships between multiple smartphones 110 and local computers 120 can be established. While 1:1 would be a typical self-study situation, 1:N could be a classroom situation where a teacher scans the machine-readable code 102 with his smartphone 110 and multiple local computers 120a, 120b, 120c, 120d of the students simultaneously display the distributed additional content 150 as shown in FIG. 2. An example of an N:N relationship is a group learning situation illustrated in FIG. 3 in which multiple students use multiple printed articles. Each student can scan a machine-readable code 102 with their smartphones 110a, 110b, 110c and the additional content will be distributed and displayed on the local computers 120a, 120b, 120c, and 120d.

Thus, according to an embodiment of the present invention enabling a 1:N relationship, a plurality of local computers 120 are connected to the network 118. A user name is transmitted from the smartphone 110 to the server computer 130, a local computer 120 is selected from the plurality of local computers 120 with the user name, and the information or content is transmitted to the selected local computer 120. Alternatively, the user name is associated with more than one local computer 120 and the same information or content is displayed on the local computers 120 associated with the user name.

In a further embodiment enabling an N:N relationship, an image of a machine-readable code 102 is captured with any of a plurality of smartphones 110a, 110b, and 110c. The machine-readable code 102 is decoded to extract information from the machine-readable code 102 with any of the plurality of smartphones 110 that captured an image. The information is transmitted from any of the plurality of smartphones 110 to the server computer 130. The server computer 130 is logged into with a user name from the local computer 120 or the server computer 120 is logged into with a user name from the smartphone 110 prior to the step of capturing an image (step 300 FIG. 4). The login for the local computer 120 and the smartphone 110 can be the same user name or, more generally, use the same credentials. The information or content associated with the information can be transmitted to a plurality of local computers 120 and the information or content associated with the information and displayed with the plurality of local computers 120 or display devices connected thereto. Examples for additional content are websites, streaming video or audio, computer programs (e.g. java applets). For example, if the content of the printed article is about the laws of planetary motion, the additional content could be a java applet that allows interactive simulation of a model solar system. A collection of interactive applets can be found at the website of the PhET Interactive Simulations Project at the University of Colorado. The Applet “Gravity and Orbits” would be a suitable example of interactive additional content to deepen the understanding of planetary motion.

The following describes an implementation of the invention on the Microsoft Windows platform. In this example, the data communication of the server computer 130 with the smartphone 110 and local computer 120 is implemented as a Windows Communication Foundation service on the server computer 130 using asp.net framework for user management, user interface and controls. Windows Communication Foundation (WCF) is a framework for building service-oriented applications. Using WCF, one can send data as asynchronous messages from one service endpoint to another. A service endpoint can be part of a continuously available service hosted by the Microsoft Internet Information Server (IIS), or it can be a service hosted in an application. An endpoint can be a client of a service that requests data from a service endpoint. The messages can be as simple as a single character or word sent as XML, or as complex as a stream of binary data.

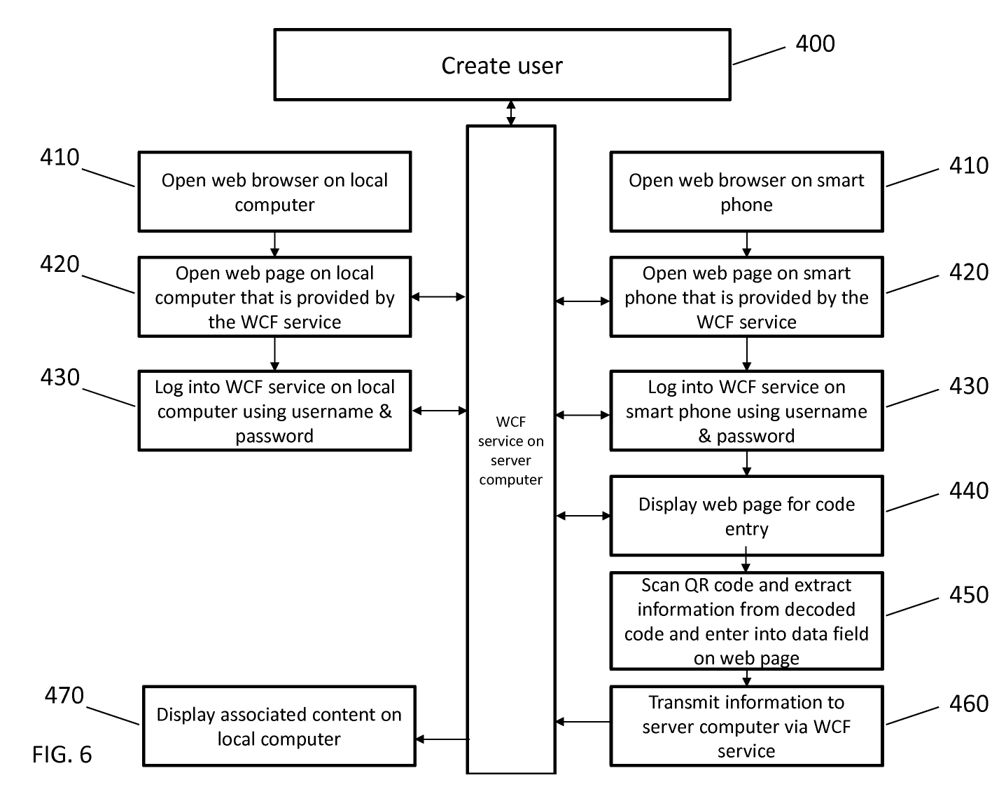

At the beginning of the transaction, a user is created in the aspnetdb database by using the appropriate functions in the asp.net framework, for example using the asp:CreateUserWizard control. The user must enter a user name, password and e-mail address for password recovery. The aspnetdb database stores the user name and e-mail address and the password in plain or encrypted format, or a hash of the password (SHA1 or MD5) for added security. It will also assign a user ID. Subsequent interactions with the WCF service are referenced by this user ID. FIG. 4 depicts schematic representations of the smartphone 110 and local computer 120. In order to establish a relationship between these two devices, the user opens a web browser 210 on both devices with a URL linking to an endpoint of the WCF service, and then logs into the service by providing the same user name and password on both devices. The asp.net login control is a suitable way to provide a user interface for the login process. Both devices are now identified to the WCF service by the same user ID. After the login procedure the web browser 210 on the touch sensitive display 111 of the smartphone 110 displays a web page containing a field for text 202 entry and a transmit button 204. The web browser 210 on the local computer 120 displays a web page containing an embedded area that can display html content, commonly called “webview” 220. The webview can be embedded in the web page using the html “iframe” tag. Subsequently, the user scans a machine-readable code 102, for example a QR code, on the smartphone 110. The information extracted from the decoded machine-readable code 102 is automatically entered into the text field. This can be accomplished, for example on an Android smartphone 110, by installing the application “Barcode Keyboard” (TEC-IT Datenverarbeitung GmbH—Steyr/Austria) as the default keyboard input method. When the text field 202 is selected, the Barcode Keyboard application provides a touch sensitive alphanumeric keyboard and an additional button 200 to start a barcode scanning process. Upon successful barcode decoding the decoded value is entered into a text entry field. The user then presses the transmit button 204 on the smartphone 110 to transmit the code value to the server computer 130. The WCF service on the server computer 130 accepts the code value that is transmitted from the smartphone 110 and stores it in a database (e.g. in memory 131) on the server computer 130 along with the user ID and optionally the date and time of the request. In the asp.net framework the button 204 is defined in the .aspx content file. The creation of a new database entry upon clicking of the button 204 achieved by executing SQL insert statements in a codebehind file associated with the content file. The local computer 120, identified to the WCF service through the same user ID, periodically polls the database on the server computer 130 for new entries of code values associated with the same user ID. Polling can be achieved using the javascript “setInterval” function which can be configured to periodically execute a function that retrieves the latest code value entry in the SQL database associated with the user ID. When a new entry is detected, the service retrieves the content 150 that is associated with the code value and transmits the content to the webview client on the local computer 120. If the code value is a URL this can be achieved by assigning the “src” attribute of the iframe to the URL. This sequence of interactions is depicted as a flow chart in FIG. 6.

Referring to FIG. 6, the interaction starts with the creation of a user account on the server computer 130 using methods of the WCF service in step 400. Subsequently, a web browser 210 is opened on both the smartphone 110 and the local computer 120 in step 410 and a web page is opened on both devices that is conveyed by the WCF service in step 420. The web page provides data entry fields to perform a log in procedure using user name and password of the user account in step 430. The web browser 210 on the local computer 120 displays no additional content after the log in procedure. After the log in procedure on the smartphone 110, a second web page is displayed in step 440 that contains a data entry field for a code value. When a QR code is scanned with the smartphone 110 in step 450, the code value is entered into this data field and transmitted to the server computer 130 via the WCF service. Subsequently the WCF service sends the content associated with the code value to the local computer 120 in step 460 which then displays it in step 470 in display 150.

An alternative way to realize the workflow on the smartphone 110 is to create a dedicated application running on the smartphone processor 114 that provides the user interface for communication with the server computer 130 and includes a barcode scanning library, for example the open source Zebra Crossing (ZXing.org) barcode decoding library.

Although the preceding example describes an implementation of the invention using the Windows-based asp.net framework, there are many alternative software platforms available to a person skilled in the art to construct such software. Among the suitable frameworks for web-based services and dynamic content are Java, Java script, PHP (personal home page), Perl, JSP (Java Server Pages), AJAX (asynchronous JavaScript and XML), DHTML (dynamic hypertext markup language).

The invention has been described in detail with particular reference to certain preferred embodiments thereof, but it will be understood that variations and modifications can be effected within the scope of the invention.

### PARTS LIST

100 printed article
102 machine-readable code
110 smartphone
110a smartphone
110b smartphone
110c smartphone
111 touch sensitive display
112 wireless transmission
113 image capture device
114 processor
115 transmitter
118 network
120 local computer
120a local computer
120b local computer
120c local computer
120d local computer
122 wireless or wired data transmission to server computer
130 server computer
131 memory
140 remote data source
150 display of retrieved content
200 scan button
202 text entry field
204 transmit button
210 web browser/http client
220 webview within web browser
300 capture image step
310 decode machine-readable code step
320 transmit information from smartphone to server computer step
330 transmit information or content from server to local computer step
340 display information or content step
400 create user account step
410 open browser step
420 open web page browser
430 login procedure step
440 display web page for code entry step
450 scan code and enter data step
460 transmit information step
470 display content step

1. A method of distributing content using a smartphone comprising:
capturing an image of a machine-readable code displayed on media with the smartphone;
decoding the machine-readable code to extract information from the machine-readable code;
transmitting the information from the smartphone to a server computer;
transmitting the information or content associated with the information from the server computer to a local computer that is different from the media; and
displaying the content associated with the information, or the information on the local computer that is different from the media.

2. The method of claim 1 wherein the information is a reference to remotely stored content and wherein the server computer retrieves the content using the reference or the local computer retrieves the content using the reference.

3. The method of claim 1 wherein the information is displayed on the local computer.

4. The method of claim 1 wherein the server computer retrieves content associated with the information from a remote source.

5. The method of claim 1 wherein the server computer retrieves content associated with the information from a memory directly connected to the server computer.

6. The method of claim 1 wherein the information is a reference to content stored on the local computer.

7. The method of claim 1 wherein the information provides access permission to the content.

8. The method of claim 1 wherein the content is selected from a group comprising a webpage, video clip, image, software program, text, or music clip.

9. The method of claim 1 wherein the machine-readable code is selected from a group comprising a QR code, barcode, data matrix code or image.

10. The method of claim 1 further comprising:
connecting a plurality of local computers to the network;
transmitting a user name from the smartphone to the server computer; and
selecting a local computer from the plurality of local computers with the user name, and transmitting the information or content to the selected local computer.

11. The method of claim 10 wherein the user name is associated with more than one local computer and the same information or content is displayed on the local computers associated with the user name.

12. The method of claim 1 further comprising:
capturing an image of a machine-readable code with any of a plurality of smartphones;
decoding the machine-readable code to extract information from the machine-readable code with any of the plurality of smartphones which captured an image; and
transmitting the information from any of the plurality of smartphones to the server computer.

13. The method of claim 1 further comprising:
logging into the server computer with a user name from the local computer; or
logging into the server computer with a user name from the smartphone prior to the step of capturing an image.

14. The method of claim 13 wherein the login for the local computer and the smartphone are the same user name.

15. The method of claim 1 wherein the machine-readable code is on a book, newspaper, magazine, poster, billboard, television, computer screen, direct mail or otherwise displayed.

16. The method of claim 1 further including:
transmitting the information or content associated with the information to a plurality of local computers; and
displaying the information or content associated with the information at the plurality of local computers.

17. The method of claim 1 wherein the information includes an alphanumeric string, a web address, a security code, a user identifier, an organization identifier, a smartphone identifier, a computer program identifier, a telephone number, geographic location coordinates, an image, or an access code that specifies referenced content or a class of content.

18. The method of claim 1 comprising:
retrieving additional content using a smartphone wherein the information is a content reference.

19. A method of distributing content using a smartphone comprising:
capturing an image of a machine-readable code displayed on media with the smartphone;
decoding the machine-readable code to extract information from the machine-readable code;
transmitting a user name and the information to a server computer;
retrieving content associated with the information at the server computer;
transmitting the retrieved content to a local computer that is different from the media; and
displaying the retrieved content at the local computer that is different from the media.

20. A method of distributing content using a smartphone comprising:
capturing an image of a machine-readable code displayed on media with the smartphone;
transmitting the image of the machine-readable code from the smartphone to a remote server computer;
decoding the machine-readable code to extract information from the machine-readable code;
retrieving content associated with the information;
transmitting the information or retrieved content associated with the information from the server computer to a local computer that is different from the media; and
displaying or playing the retrieved content associated with the information or the information on the local computer that is different from the media.

21. A system for distributing content including a smartphone, comprising:
a network for transmitting information and content;
a smartphone connected to the network wherein the smartphone includes an image-capture device for capturing an image of a machine-readable code displayed on media, a processor for decoding the machine-readable code to extract information, and a transmitter for transmitting the information over the network;
a server computer connected to the smartphone by the network wherein the server includes a receiver for receiving information from the smartphone, a processor for retrieving content and a transmitter for transmitting either the information or retrieved content associated with the information over the network; and
a local computer that is different from the media including a receiver for receiving the retrieved content or information over the network from the server computer and a display for displaying the retrieved content, retrieved content associated with the information, or the information and an output device for displaying the retrieved content, retrieved content associated with the information, or the information.
